(19) United States
(12) Patent Application Publication
(10) Pub. No.: US 2005/0111453 A1
(43) Pub. Date: May 26, 2005

(54) Packet distributing method, information forwarder, and network system

(76) Inventor: Masahiko Mizutani, Tokyo (JP)

Correspondence Address: Stanley P. Fisher;Reed Smith LLP, Suite 1400, 3110 Fairview Park Drive, Falls Church, VA, 22042-4503, US

(21) Appl. No.: 10/986,828

(22) Filed: Nov. 15, 2004

(30) Foreign Application Priority Data
Nov. 20, 2003 (JP) 2003-390850

(51) Int. Cl. H04L 12/56

(52) U.S. Cl. 370/390; 370/432; 370/392

(57) ABSTRACT

To decrease a load on a network when a large quantity of data is distributed to a plurality of points at the same time. This invention provides a packet distributing method of distributing a data packet in a network system provided with a plurality of information forwarders (1), the information forwarder (1) including a forwarding table to specify a route of the network system by using an identifier identified in an application layer, including: setting the route on the basis of a forwarding information identified in the application layer, for the information forwarder (1) on a destination from the information forwarder (1) on an upper stream; receiving the data packet; determining a destination of the data packet according to an information included in the received data packet and the forwarding table; and transmitting the received data packet, on the basis of the determined destination.

### CLAIM OF PRIORITY

The present application claims priority from Japanese application P2003-390850 filed on Nov. 20, 2003, the content of which is hereby incorporated by reference into this application.

### BACKGROUND

This invention relates to a method of distributing a large quantity of content to a plurality of points at the same time, and more particularly to a packet distributing method, an information forwarder, and a network system which decrease a load on a network when a large quantity of content is distributed to a plurality of points at the same time.

The currently globally spread communication protocol is Internet Protocol (IP). An IP connection function is supported in many network connection devices. This IP connection function is intended to the communication of Point-to-Point, and this is the protocol targeting only communication of a simple control signals and communication on the text basis. In those, forwarding information is independently informed between routers through the protocol, such as Routing information Protocol (RIP), Open Shortest Path First (OSPF), or Boarder Gateway Protocol (BGP4). The forwarding information is generated as a forwarding table and held in each router. The router transmits a packet to the optimal route while referring to the forwarding table on the basis of the destination information included in an IP packet.

An IP network is a best effort method, and there is no insurance of a communication band at the time of the data packet transmission. So, typically, the forwarding on a route is insured by using a transport layer protocol located in a higher network layer of an ISO reference model, and the forwarding in linkage with the IP network is controlled.

The popularization of the IP network increases the demand for the information distribution on the network. As a method of securely transmitting and receiving information on the IP network, typically, there are techniques of Virtual Private Network (VPN), Virtual LAN (VLAN), and the like. Although the techniques have a plurality of ways, respectively, the VPN is the technique for reserving a communication route for each user on the IP network and consequently enabling the usage of the virtual network such as a dedicated network, and the VLAN is the technique for controlling the route in a data link layer, in linkage between an L2 switch and a router, when the communication route is similarly reserved. The VPN is a means in which a different person's packet can simultaneously exist on the reserved route. However, the VLAN enables the securer communication without any invasion of the other packet onto the route. Also, in a currently popularized IPv6, Security Architecture for Internet Protocol (IPsec) which is a protocol to reserve the security is supported as a standard, and the concern for the security increases.

Together with the above-mentioned popularization of the network as information infrastructure, the distribution of a large quantity of data in which WWW is used is enlarged. The IP network has a problem in that most of traffics are concentrated on the particular route calculated as the optimal route because of that protocol design. In particular, when the large quantity of data, such as an image or the like, is distributed from a server through the Internet to unspecified many users, this problem of the IP network causes the drop in the distribution efficiency. For this problem, there is a method in which in Content Delivery Network (CDN), the cache of the data is contained on the user side of the network, a plurality of servers are further prepared, the data where the cache is effectively utilized is distributed, the distribution server is switched on the basis of the connection position of the user on the network, the load is reduced, and the distribution efficiency to the user is improved at the same time. However, in this CDN, there is no efficient technique with regard to the network control at the time of the data distribution.

In recent years, attention has been paid to the communication on the network through multi-media data such as image and voice. In the system where a plurality of users participate at the same time, such as a television meeting and the like, a large quantity of data such as dynamic image, voice, and the like needs to be distributed to a plurality of locations at the same time. So, the employment of IP multicast enables the information to be distributed to the many locations on the IP network. In the IP multicast, the data is distributed by preparing the address of an IP multicast group address, and preparing a forwarding table referred to as a multicast forwarding table adding to a usual forwarding table held by a router, and then using a multicast packet in which only the IP multicast group address is a destination address. As the method of distributing the data by using this IP multicast, a method of multicasting a data packet under the control of an application layer is known (for example, refer to JP 2003-188918 A).

### SUMMARY

In association with the popularization of World Wide Web (WWW) and the popularization of Asymmetric Digital Subscriber Line (ADSL), Cable Television (CATV), Fibre To The Home (FTTH) in recent years, the number of network users sharply increases, and a broadband environment together with a mobile technique becomes an inevitable infrastructure even in business. As for the information distribution on the network, attention is currently paid to a fee-charging content distributing service of a large quantity of content, in which image is especially centralized. Also, a broadcast industry tries to establish the information distribution on the network, and plans to attain the re-broadcast service from the image archives prepared until that time by using the server and the network. On the other hand, in the situation where unification of tasks as information is advanced, the network using a method in which a large quantity of information is shared through the network between branches or a backup system is established for a plurality of bases in preparation for disaster is considered for the data in a mainframe for a bank group and the like.

In order to distribute the image data and share the main group task data, the large quantity of data needs to be distributed to the plurality of hubs. In the conventional network technique, a uni-cast method is mainly used. Thus, if the large quantity of data is sent to the plurality of hubs at the same time, a large load is imposed on the network near a source, which results in problems of drops in a network forwarding efficiency and a server processing efficiency.

In association with the larger capacity of data, the introduction of the IP multicast advances. In the IP multicast, information is added to an UDP packet and transmitted. However, its main purpose is to distribute the data used in real time. This does not include a means for compensating the packet loss caused by the congestion in the course of a route and the like, and this does not improve the communication quality in the course of the route.

This invention is proposed in view of the above-mentioned problems. It is therefore an object of this invention to provide a multicast communication method and a device that are suitable for a large quantity of data distribution, which can reserve the reliability (communication quality) of data of a communication (multicast) in a many-point simultaneity communication of a large quantity of data, reduce a network load at a time of data distribution and improve an distribution efficiency, and also co-exist and easily link with the conventional technique.

According to this invention, in a network constituted by an information forwarder that forwards a data packet and transmits an information, forwarding information is configured by forwarding information identified in an application layer, the data packet is generated in the application layer, and the forwarding information identified in the application layer is included as destination group address information of a packet, and when the same information is transmitted to a plurality of receivers connected to the network, with regard to the portion common in the route from a source to a destination, a method for the network includes a data packet transmitting step of using a destination address to transmit the information through one data packet transmission, a step of establishing a forwarding information entry (multicast forwarding table) common in the plurality of destinations from application layer network structure information, a step of judging the destination of the data packet in the forwarder, and a step of transmitting the data packet on the basis of the destination information. The data packet may be stored in a storage section contained in the information forwarder.

Due to this invention, it is possible to reserve the reliability in the communication of the many-point distribution (multicast) of the large quantity of data and possible to improve the distribution efficiency. Also, by storing the data packet on the transmission route, it is possible to disperse a network load when the large quantity of data is distributed, and possible to protect the network load of a distribution source from being excessive. Moreover, the application of this invention to a conventional packet distributing method enables the easy introduction to a conventional network system.

### BRIEF DESCRIPTION OF THE DRAWINGS

FIG. 1 is a configuration block diagram of a network system according to a first embodiment of this invention.

FIG. 2 is a configuration block diagram of an L7 multicast data packet according to the first embodiment of this invention.

FIG. 3 is a configuration block diagram of an L7 multicast forwarding table according to the first embodiment of this invention.

FIG. 4 is a configuration block diagram of a data packet according to the first embodiment of this invention.

FIG. 5 is an explanatory view of a protocol stack according to the first embodiment of this invention.

FIG. 6 is a configuration block diagram of an L7 multicast packet forwarder 1 according to the first embodiment of this invention.

FIG. 7 is a flowchart of a generating process of a data packet according to the first embodiment of this invention.

FIG. 8 is a flowchart of a forwarding process according to the first embodiment of this invention.

FIG. 9 is configuration block diagram of an L7 multicast domain according to a second embodiment of this invention.

FIG. 10 is a sequence diagram of a data transmitting process according to the second embodiment of this invention.

FIG. 11 is an explanatory view of a protocol stack according to the second embodiment of this invention.

FIG. 12 is a configuration block diagram of an information forwarder 1000 according to the second embodiment of this invention.

FIG. 13 is a flowchart of a forwarding process according to the second embodiment of this invention.

FIG. 14 is a flowchart of a transmission checking process of a data packet according to the second embodiment of this invention.

FIG. 15 is a flowchart of a session establishing process according to the second embodiment of this invention.

FIG. 16 is a flowchart of a retransmitting process of a data packet according to the second embodiment of this invention.

FIG. 17 is a configuration block diagram of a retransmission requesting packet according to the second embodiment of this invention.

FIG. 18 is a flowchart of a process of an information forwarder 1000 according to a third embodiment of this invention.

FIG. 19 is a configuration block diagram of a multicast forwarding table (L7 multicast forwarding table), in the third embodiment of this invention.

FIG. 20 is an explanatory view of a protocol stack according to the third embodiment of this invention.

FIG. 21 is a flowchart of a transmitting process according to the third embodiment of this invention.

FIG. 22 is a flowchart of a path control process between information forwarders according to the third embodiment of this invention.

### DESCRIPTION OF THE PREFERRED EMBODIMENTS

Embodiments of this invention will be described below with reference to the drawings.

This invention proposes a purpose of improving the reliability and distribution efficiency at the time of the distribution of the large quantity of data to many points, in the manner that enables the co-existence with the network established in the conventional technique and enables the achievement of higher reliability functions due to the linkage between layers. Also, this invention proposes a forwarding control method that enables the reduction in a network load by using the feature of the higher layer and enables the connection between different kind networks by using the attribute information of content, the various services, and the user information.

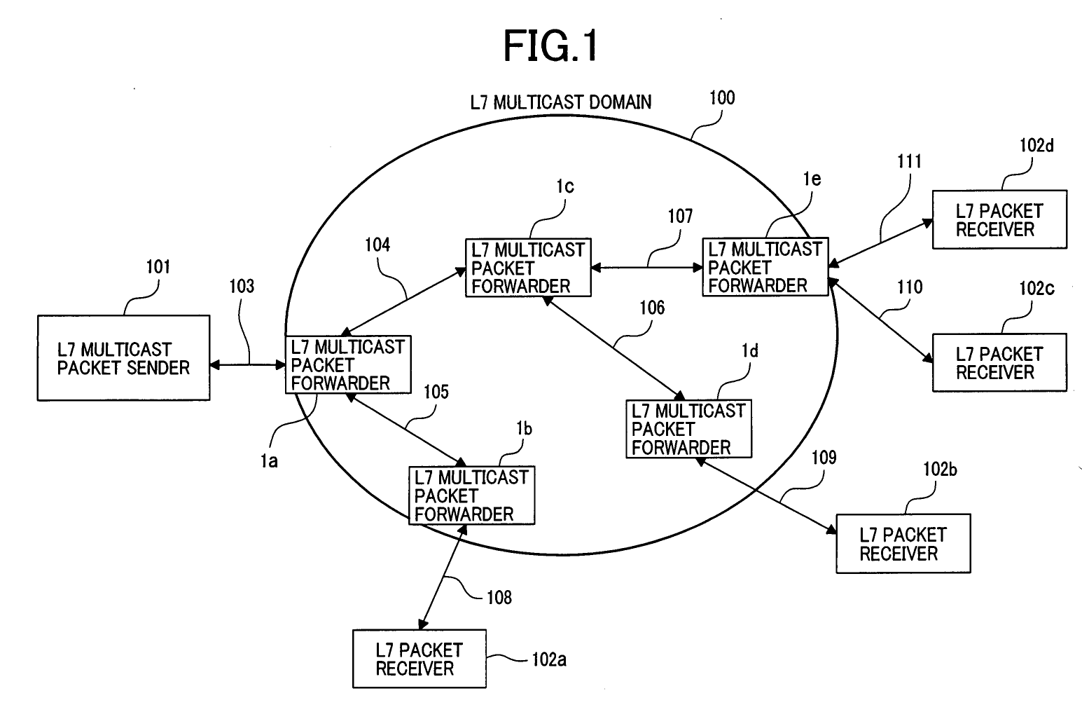

FIG. 1 is a configuration block diagram of a network system according to a first embodiment of this invention.

In this invention, a layer higher than a transport layer in the OSI reference mode is referred to as “L7” or “Application Layer”.

The network system in the first embodiment is constituted in an application layer network 100 including respective node devices: an application layer multicast sender (hereafter, referred to as “L7 Multicast sender” 101; application layer data packet forwarders (hereafter, referred to as “L7 Multicast Packet Forwarder”) 1a to 1e; and receivers 102 to 105.

The L7 multicast sender 101, the L7 packet forwarder 1, and the receiver 102 use the identifiers singly represented on the network in the application layer as the L7 network address. The L7 multicast sender 101, the L7 packet forwarder 1, and the receiver 102 are connected to each other by using the network, such as a physical line of Ethernet and the like, a wireless LAN, and logically identified connection ports. The network topology in the application layer is logically configured independently of the network establishment in the conventional network layer. The configuration may be different from the topology represented by the protocol of a lower layer.

Each of the logical connection ports contained by the L7 packet forwarders 1a to 1e has an L7 network address represented by an identifier of an application layer (L7). Each of the L7 packet forwarders 1a to 1e holds in the device an L7 forwarding table based on the L7 network address information. The information of the L7 network addresses is informed through the L7 packet forwarders 1a to 1e to each other, or set for the respective L7 packet forwarders 1a to 1e by a manager.

The data (content) held in the L7 multicast sender 101 is fragmented into necessary packet sizes, and the header for the L7 multicast domain is added thereto, and it is transmitted to the L7 packet forwarder 1 in the L7 multicast domain. The L7 packet forwarders 1a to 1e receiving the data packet having the L7 multicast address, refer to an L7 forwarding table of the self-device, and transmit the data packet to the receiver 102 belonging to a multicast group that is a destination of the data packet.

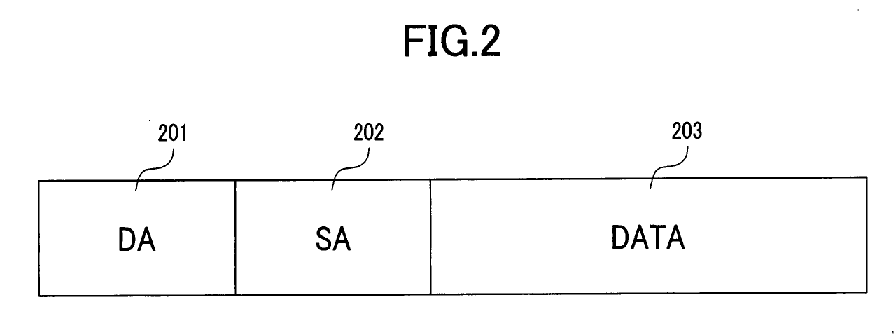

FIG. 2 is a configuration block diagram of an L7 multicast data packet according to the first embodiment of this invention.

The packet is composed of a header section and a data section 203. The header section is composed of a destination address (DA) 201 of the L7 multicast represented by an identifier to identify the information of the application layer and a source address (SA) 202 to identify a source of the L7 multicast address. The destination address retrieving process of the packet in the multicast determines an entry in which the destination address (DA) 201 and the source address (SA) 202 are coincident with each other, as the destination of a next hop, from the table entry registered in the forwarding table.

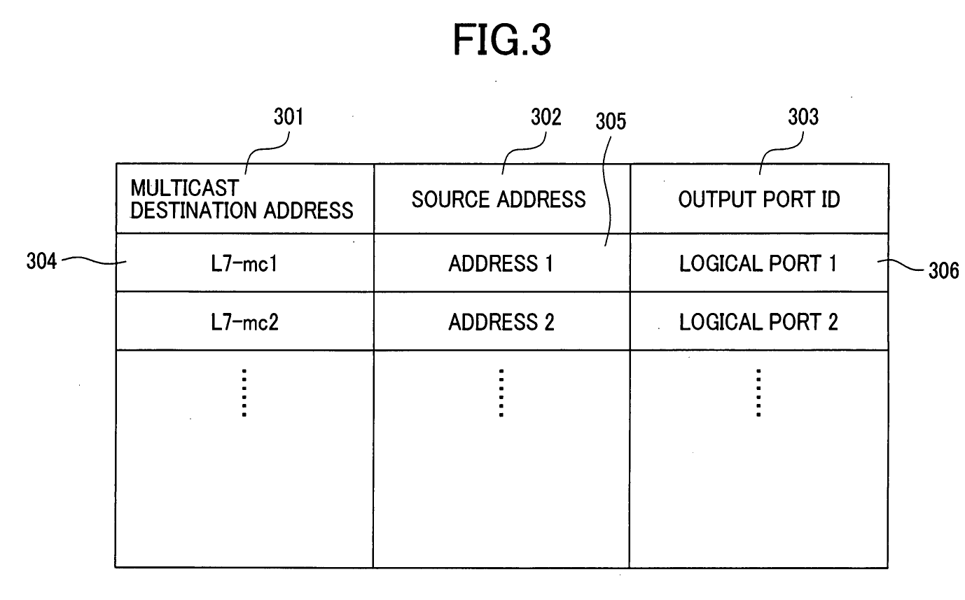

FIG. 3 is a configuration block diagram of the forwarding table (L7 multicast forwarding table) used by the L7 packet forwarder, in the first embodiment of this invention.

The L7 multicast forwarding table includes: a multicast destination address 301 that is an identifier of L7; an L7 network address (source address) 302 that is an identifier of the source; and an output port ID 303 that is represention of a next destination of the L7 multicast group.

The multicast destination address 301 and source address 302 which are located at the entry of the L7 multicast forwarding table are addresses (304, 305) both identified on the logical network in the application layer. The multicast destination address 301 is such that the L7 network addresses which can be singly identified on the network are grouped. Also, the output port ID 303 is an identifier (306) of a logical port number to transmit the data packet to a next forwarder. This identifier uses a port name, or a physical or logical network address of a port and the like.

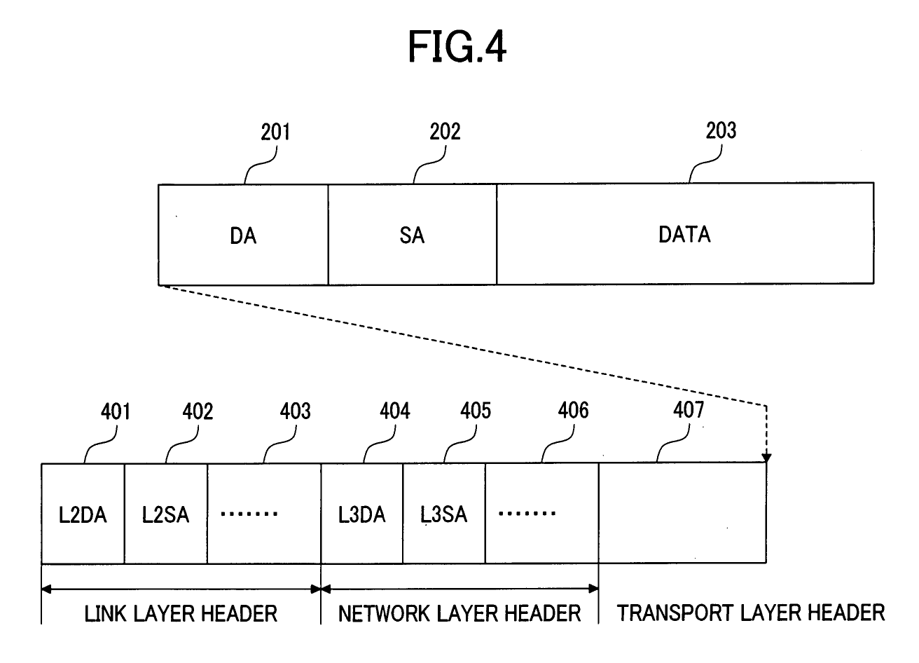

FIG. 4 is a configuration block diagram of the data packet according to the first embodiment of this invention.

When the above-mentioned L7 multicast data packet is applied to the network such as the conventional TCP/IP, as shown in FIG. 4, a header 407 of a transport layer to perform a transmission control on the packet, a destination address 404 in a network layer, a source address 405, the other network layer header 406, a destination address 401 to identify a device in a data link layer, a source address 402, and the other link layer header 403 are added to the packet.

As for the L7 multicast data packet, the L7 multicast sender 101 fragments the data in the application layer, and the header including a destination group address in Layer 7 and a source address is added thereto, and it is transmitted. In transmitting, the port number of the conventional transport layer and Layer 7, the address information in the network layer, and the device address information in a data link layer are correlated. Then, the L7 multicast data packet is transmitted from the physical network interface after the header with regard to the protocol of each layer is added to the L7 multicast packet. In this way, by changing the correlation between the protocols of the application layer, and the transport layer and the network layer, it is possible to transmit the data packet by using a different protocol. Consequently, more flexible network establishment becomes possible.

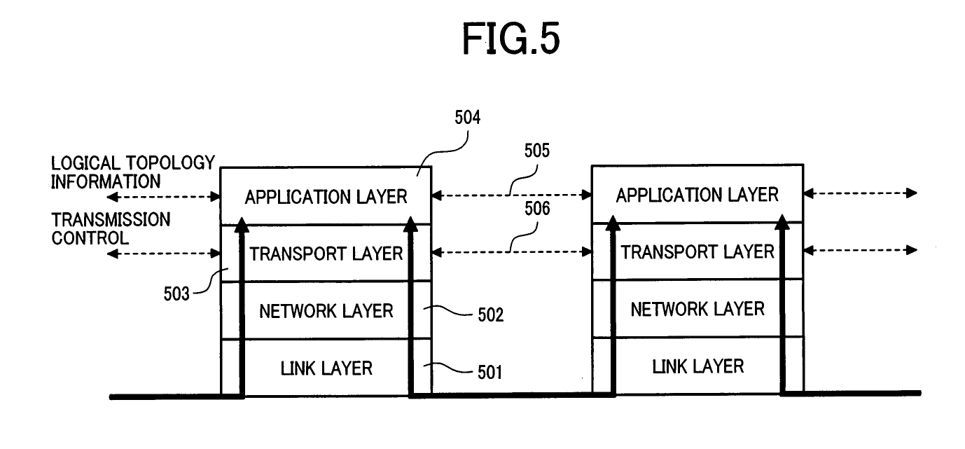

FIG. 5 is an explanatory view of a protocol stack used in the L7 multicast.

Here, the layers at and above the session layer (fifth layer) in the 7-layer model of OSI are represented by an application layer 504.

The forwarding control information (logical topology information) including the address information in the application layer 504 is informed between the L7 packet forwarders 1 (505). The transmission control of the packet may be attained in the application layer 504, or by a communication 506 between existing transport layers 503. The data packet received through the physical line is protocol-processed in the order of the data link layer 501, the network layer 502, the transport layer 503, and the application layer 504. Then, after the route is selected in the application layer 504, in the process opposite to the receiving case, it is transmitted to a next L7 packet forwarder 1. This forwarding control is independently executed in the application layer 504, and this has no influence on the other existing layer processes. In this way, the linkage of the processes between the respective layers attains the flexibility and high reliability of the forwarding control between the different protocols.

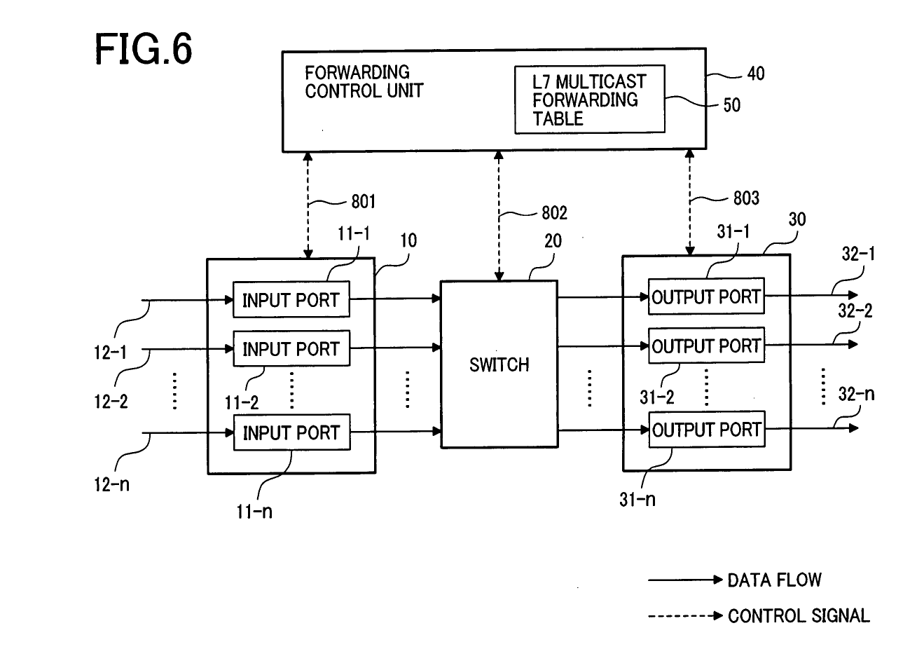

FIG. 6 is a configuration block diagram of the L7 packet forwarders 1 (1a to 1e in FIG. 1, and hereafter, they are similarly indicated) according to the first embodiment of this invention.

The L7 packet forwarder 1 includes: a input unit 10 having logical lines 12-1 to 12-n and a plurality of input ports 11-1 to 11-n; a output unit 30 having a plurality of output ports 31-1 to 31-n; a switch unit 20 for switching the routes among logical lines 32-1 to 32-n, the input ports 11-1 to 11-n, and the output ports 31-1 to 31-n; and a forwarding control unit 40 for referring to an L7 multicast forwarding table 50 from the destination L7 multicast group address of the received packet and determining the destination port of the data packet.

The input unit 10 extracts the L7 header including the destination group information from the L7 multicast packets received by the input ports 11-1 to 11-n, and informs it to the forwarding control unit 40. The forwarding control unit 40 retrieves the L7 multicast forwarding table 50 on the basis of the header, and correlates the input ports 11-1 to 11-n to the output ports 31-1 to 31-n on the basis of the retrieved result. Then, the correlated connection information is informed to the switch unit 20. The switch unit 20 switches the connection among the ports according to the connection information informed from the forwarding control unit 40. Consequently, the data packet received by the input unit 10 is transmitted to the output unit 30. The output unit 30 carries out the header processing (for example, the change of the destination or the source identifier) as necessary according to the connection information from the forwarding control unit 40, and transmits the data packet from the output ports 31-1 to 31-n through transmission lines 32-1 to 32-n.

As the retrieved result of the L7 multicast forwarding table 50, if a plurality of sources are judged to exist, the forwarding control unit 40 instructs at least one of the input unit 10 and the output unit 30 to duplicate the data packet on the basis of the control signal of the connection information.

FIG. 6 shows the configuration of the functions identified in the application layer, and the linking method to the lower layer is irrelevant. Also, the functions of respective components may be attained by software or hardware. Also, the function attained inside one device may be attained by the linkage between a plurality of devices.

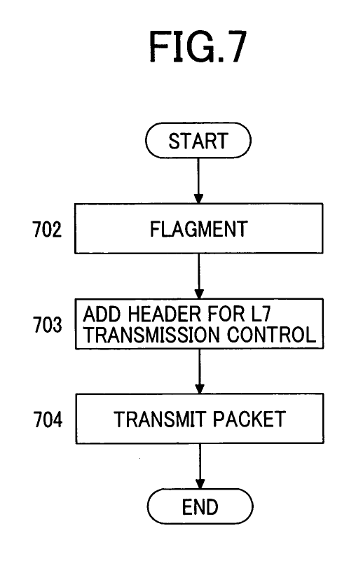

FIG. 7 is a flowchart showing a generating process of the data packet in the L7 multicast sender 101.

In the L7 multicast sender 101, the data to be transmitted is firstly fragmented into necessary sizes (702). Next, the header necessary for the L7 multicast forwarding is added to each fragmented piece (703). Then, each data packet to which the header is added is transmitted from a logical port connected to the L7 multicast domain (704).

As shown in FIG. 2, the header necessary for the multicast forwarding includes: an L7 multicast group address that is an identifier on the logical network composed of the application layers; and a source network address that is an identifier of the source sender at Layer 7. Moreover, examples of the information indicating the content of the data packet include a data ID that is an identifier of transmission data and a sequence number of a packet to be identified on the network.

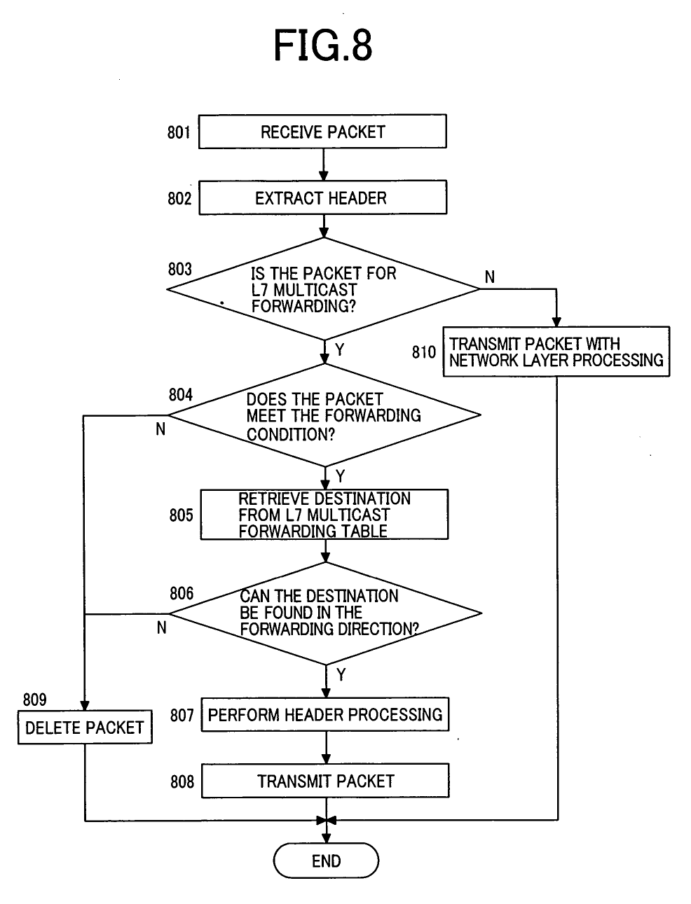

FIG. 8 is a flowchart of a forwarding process of the data packet in the L7 packet forwarder 1.

In the forwarder 1, the input ports 11-1 to 11-n receive the data packet through logical lines 12-1 to 12-n (801). The input unit 10 extracts the header from the received data packet (802). Next, with reference to the extracted header, whether or not the data packet is the packet of the target of the L7 multicast forwarding is judged (803). If it is not the packet of the target of the multicast, the transmitting process in the usual network layer, or the transmitting process of the higher layer by using the network address defined in the application layer is carried out (810), and the process is ended. If the received data packet is the data packet of the target of the multicast, the flow of the process proceeds to a step 804.

In the multicast transmitting of the IP network, the function of limiting the arrival range of the multicast packet (for example, the arrival limit based on the number of effective next hops or VPN) is used so as not to increase the traffic on the network unnecessarily. Even the case of the multicast in the application layer in this invention is similarly processed. That is, the forwarding limit information to limit the arrival range is given to the header. Then, whether or not the header has the forwarding limit information is judged. Specifically, whether or not the forwarding limit exceeds the defined number of the hops and the data packet can be forwarded to a next hop is judged (804). When judged that the data packet that cannot be forwarded exists because the packet already exceeds the defined number of the hops or other reasons, the received data packet and the information with regard to the data packet are deleted, and the forwarding process is ended (809).

At the step 804, when the data packet is judged to be forwarded, with reference to the L7 multicast forwarding table 50 of the forwarding control unit 40, the destination group address and the source L7 network address are retrieved from the header, and the destination port is determined (805). When it is judged as the retrieved result of the L7 multicast forwarding table 50 that the destination information of the data packet cannot be obtained or the destination of the terminal or the like belonging to the multicast group address does not exist in the destination of the self-device, the received data packet and the information with regard to the data packet are deleted, and the forwarding process is ended (809). When the destination of the data packet is judged to exist, the necessary process of the header and the duplicating process of the packet corresponding to the number of the destinations are carried out (807). Then, from the output port corresponding to the destination, the data packet is transmitted to the node that is the next hop (the L7 packet forwarder 1, the receiver 102, and the like) (808), and the forwarding process is ended.

Through the above-mentioned processes of FIG. 8, the L7 multicast data packet received by the L7 packet forwarder 1 can be transmitted to the next L7 packet forwarder 1 or receiver 102 (the L7 packet receivers 102a to 102d of FIG. 1) and the like.

It should be noted that this order of the processes of FIG. 8 is merely an example. The order of the similar processes may be changed, or the plurality of processes may be processed in parallel, if possible. For example, another method may be considered as the process when the received packet is not the multicast packet. However, this invention does not limit the application thereto.

A network system of a second embodiment of this invention will be described below. The second embodiment of this invention is designed such that each storage unit is connected to a node (an information forwarder 1000) for forwarding the data packet of the L7 multicast, and the data packet is temporarily stored in the information forwarder 1000. The same symbols are given to the configurations carrying out the same actions as the first embodiment, and explanation thereof are omitted.

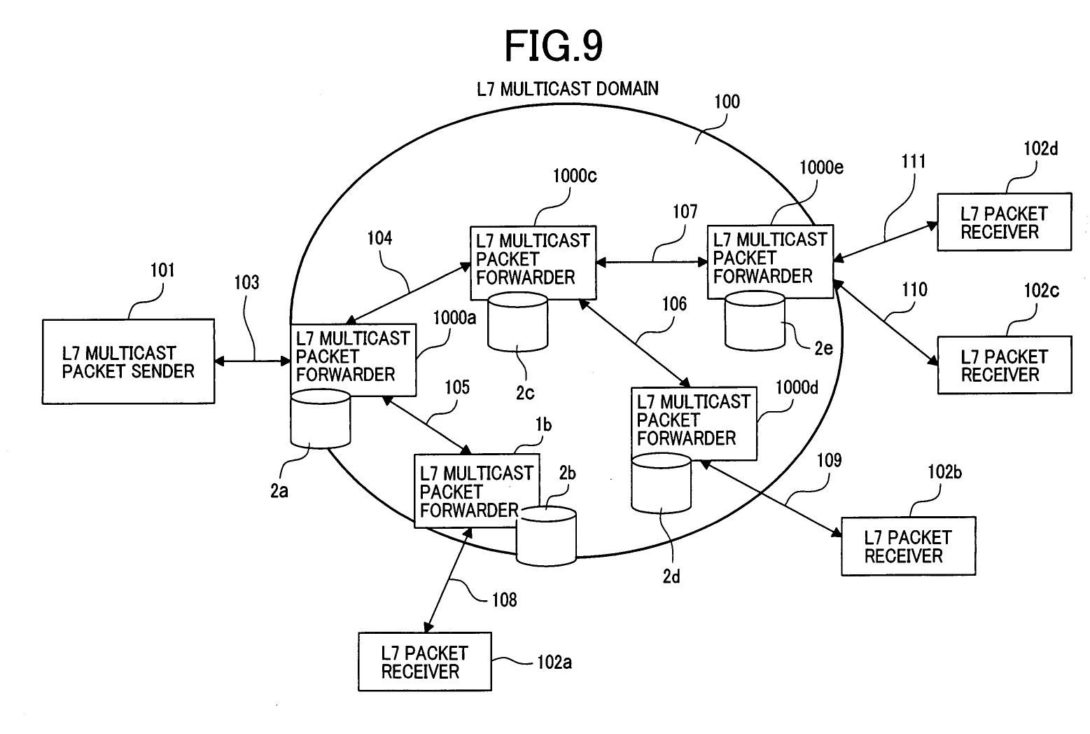

FIG. 9 is a block diagram of the configuration of the L7 multicast domain composed of information forwarders 1000a to 1000e having storage units 2a to 2e, in the second embodiment of this invention.

The L7 multicast domain 100 is characterized by using the identifier (ID), which can be identified in the application layer, as the network address. For this reason, at the time of the transmitting process in the higher layer, the information to be communicated on the network (typically, data or content) can be identified not only as the packet type such as the forwarding in the conventional network layer, but also as a file type.

The feature of this L7 multicast method is used to store the data packet received by the information forwarder 1000 in the storage unit 2 inside the information forwarder 1000. Then, the content is treated in unit of file that is reestablished from the data packet stored in the storage unit 2, and the transmission control is carried out by considering the priority of the information and the like. Consequently, the traffic can be smoothed, which reduces the load of the network and improves the data transmission efficiency.

Also, in addition to the smoothing of the traffic as mentioned above, the content is transiently stored in the information forwarder 1000. Thus, among the information forwarders 1000 belonging to a multicast distribution tree that distributes the data packet, at the time of the completion of the distribution of the content to the next information forwarder 1000 from the upper stream information forwarder 1000, communication paths (session) can be sequentially released from the distribution tree. Simultaneously with the completion of the distribution, by opening the session between the information forwarders 1000, the upper stream information forwarder 1000 can treat with a next data flow. Consequently, if a large quantity of information traffic exists on the network, the usage efficiency of a network resource can be greatly improved.

The conventional IP multicast method distributes a real time system data through the UDP packet. For this reason, the countermeasures against the loss of the data packet on the route caused by the congestion of the network and the quality deterioration in the reception data in association therewith are not prepared. For this reason, if a part of data is lost, the conventional IP multicast method again requests the multicast sender to retransmit the data, and the same data is transmitted. Thus, the application of the conventional method to the data (for example, the data on which the security control is performed) needing the reliability such as the mainframe task data causes the same data to be repeatedly transmitted on the network, which is not suitable. Also, in association with the larger quantity of content, the retransmission of the data is also repeatedly generated, which excessively increases the load on the network.

In the second embodiment of this invention, the transmitted data after the division into the packet units is once reestablished as the content in the information forwarder 1000. Consequently, even if a part of the packet forwarding on the route is lost, the retransmission is requested between the information forwarders 1000. Thus, the retransmission of the packet passed from the server over the entire route to the node at the end is not generated, which can reduce the load on the network and also improve the reliability of the large quantity of data transmission.

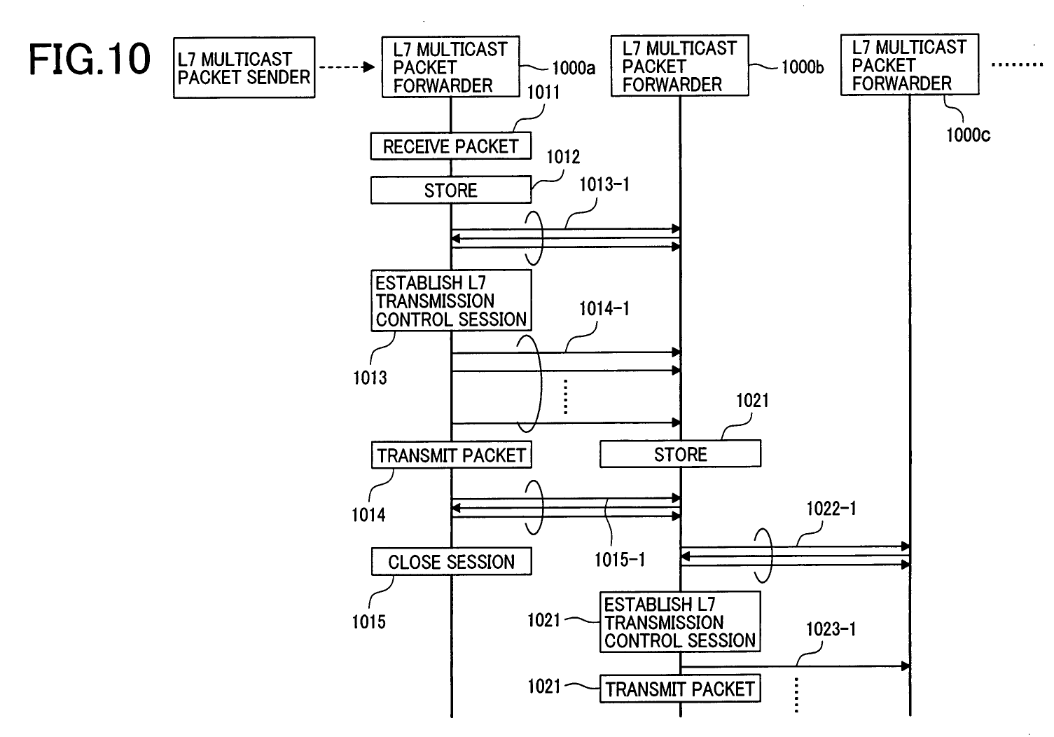

FIG. 10 is a sequence diagram of the data transmitting process between the information forwarders 1000.

In FIG. 10, as for the data packet transmitted from the L7 multicast sender 101, an L7 multicast distribution tree is configured in which the data flows in the order of the information forwarder 1000a, the information forwarder 1000b, and the information forwarder 1000c from the upper stream side.

Each of the information forwarders 1000a to 1000c records the data information contained in the received data packet in the storage unit 2, in order to hold the data reestablished from a data packet or the plurality of data packets. At this time, the data packet may be stored in its original format, or may be stored in the mode of the data (content) reestablished from the data packet.

In order to make use of this storage function, the transmission of the data packet is checked between the respective information forwarders 1000a to 1000c in the multicast distribution tree. At first, the information forwarder 1000a receiving the data packet from the upper stream information forwarder (or the sender) (1011), stores the information of the received data packet in the storage unit 2a of the self-device (1012). The information forwarder refers to the L7 multicast forwarding table 50 from the header of the data packet and carries out a forwarding process for retrieving the downstream node (1013-1), and then carries out a session establishing process (1013) for establishing the session for the data packet transfer and transmission check between itself and the next information forwarder 1000b.

The information forwarder 1000a uses the established session and sequentially transmits the data packet to the information forwarder 1000b (1014). When stored as the data packet, the packet is transmitted in its original state. If the data packet is reestablished as the content, the content is again fragmented into packets. Then, the header is added to each packet, and it is transmitted.

At the time of the transmission of each data packet, the transmission check is executed. At this time, when the transmission check cannot be done and the data packet transmission fails, the data packet is again read from the storage unit 2a, and transmitted to the information forwarder 1000b. When the transmitting process (1014) of all of the necessary data packets is completed, the session between the information forwarders 1000a and 1000b is closed to release the session (1015).

The information forwarder 1000b receiving the data packet, uses the similar method(step 1011 to 1015), stores the information in the storage unit 2b of the self-device, and then transmits the data packet to the further downstream information forwarder 1000c. The data packet may be transmitted to the downstream information forwarder 1000 immediately after the arrival. Also, after the completion of the arrival of all of the data packets, the data reestablished in the storage unit 2 may be transmitted to the downstream information forwarder 1000 again as the data packet.

The session managing function is attained by the linkage to the storage function. By releasing the sessions except that between the information forwarders 1000 with regard to the packet transmission, it is possible to improve the transmission efficiency if there are a plurality of large quantity of traffics at the same time.

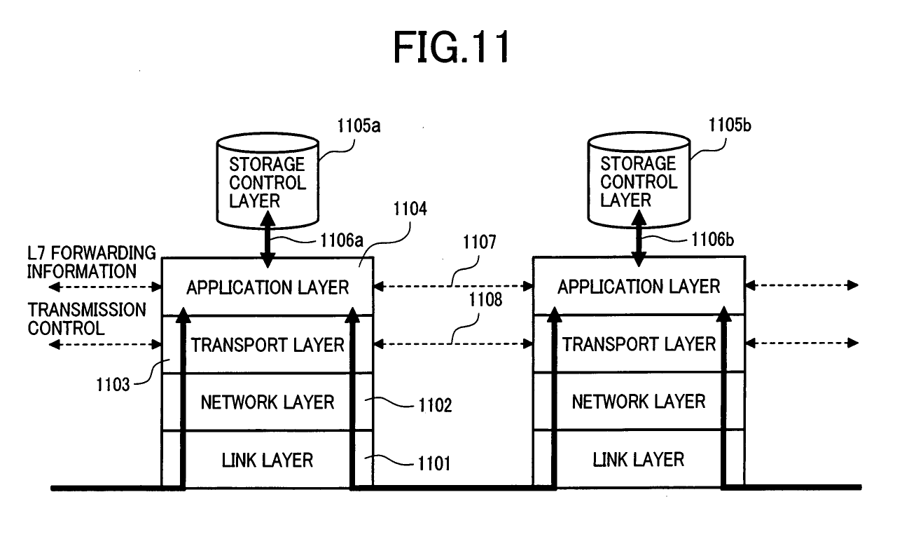

FIG. 11 is an explanatory view of a protocol stack used in the L7 multicast according to the second embodiment of this invention.

Similarly to FIG. 5 as mentioned above, the layers at or above the session layer (fifth layer) in the 7-layer model of OSI are represented by an application layer 1104. The relation from a data link layer 1101 to the application layer 1104 is similar to the explanation of FIG. 5. In the storage linkage, in addition to the usual application layer 1104, there is a storage control layer 1105 for carrying out the control of the storage (for example, the control of an SCSI command).

Since a device for identifying data and service is closely related to the storage control, the storage control layer 1105 and the application layer may be collectively referred to as the application layer. The report of the usage state of the storage and the storage control at the time of the data packet transmission are controlled by a report 1106 from the application layer 1 104.

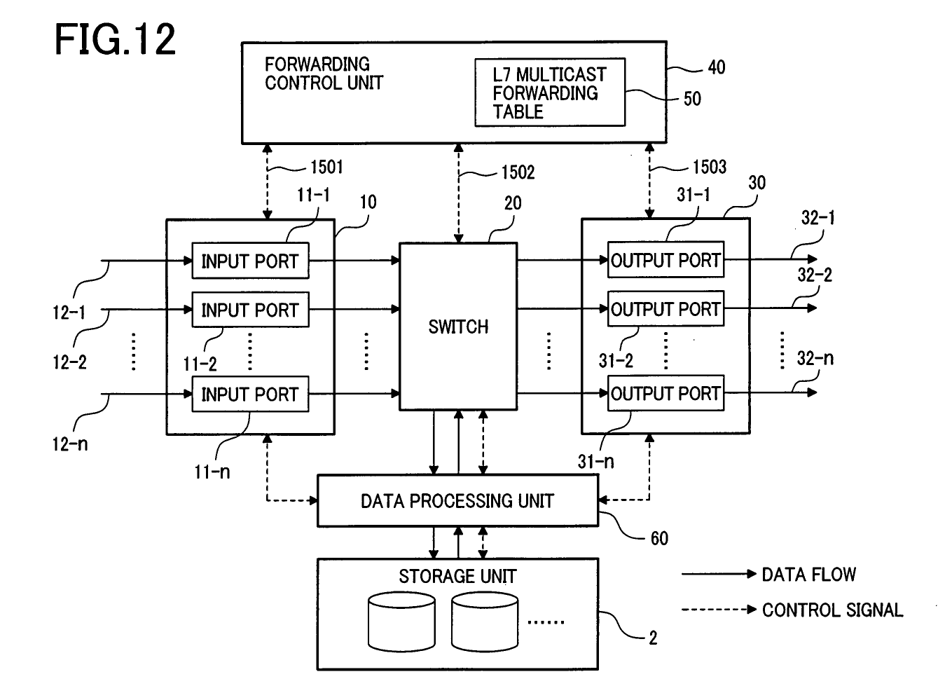

FIG. 12 is a configuration block diagram of the information forwarder 1000 having the storage unit 2 according to the second embodiment of this invention.

The information forwarder 1000 includes: the input unit 10 having the logical lines 12-1 to 12-n and the plurality of input ports 11-1 to 11-n; the output unit 30 having the plurality of output ports 31-1 to 31-n; the switch unit 20 for switching the routes between the logical lines 32-1 to 32-n, the input ports 11-1 to 11-n and the output ports 31-1 to 31-n; and the forwarding control unit 40 for referring to the L7 multicast forwarding table 50 from the destination L7 multicast group address of the received packet and determining the destination port of the data packet. Since the components are the same as those of FIG. 6 mentioned above, explanations thereof are omitted.

The information forwarder 1000 further includes the storage unit 2 for storing the information contained in the data packet received by the input unit 10, and a data processing unit 60. The data processing unit 60 reestablishes the received data packet to the packet format or the data format from the series of data packets and transmits to the storage unit 2. Also, the data processing unit 60 receiving the retransmission request of the data packet, provides the function of reestablishing the data packet from the information stored in the storage section, on the basis of the request.

In the switch unit 20, as the logical port, in addition to the input ports 11-1 to 11-n and output ports 31-1 to 31-n, the logical port connected to the data processing unit 60 is targeted for the connection. Through the logical port connected to this data processing unit 60 or storage unit 2, the reception data packet information is stored in the storage unit 2. Also, the data packet information is read from the storage unit 2.

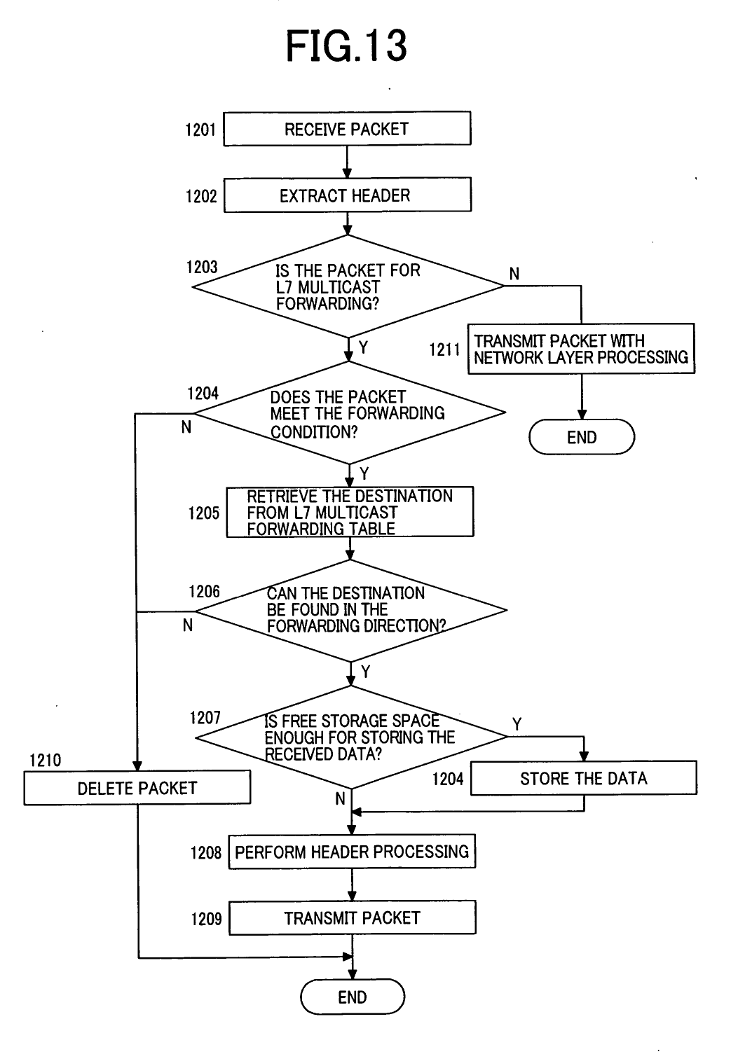

FIG. 13 is a flowchart of the forwarding process in the information forwarder 1000 according to the second embodiment of this invention.

In the information forwarder 1000, the input ports 11-1 to 11-n receives the data packet through the logical lines 12-1 to 12-2 (1201). The input unit 10 extracts the header from the received data packet (1202). Next, with reference to the extracted header, whether or not the received data packet is the L7 multicast packet is judged (1203). If it is not the packet of the target of the multicast, the transmitting process is carried out by the transmitting process in the usual application layer, or the transmitting process of the higher layer by using the network address defined in the application layer (1211). If the reception packet is judged to be the packet of the target of the L7 multicast, the method similar to FIG. 8 as mentioned above is used to judge whether or not the packet meets the forwarding condition (1204). If the packet can be forwarded, the L7 multicast forwarding table 50 is used to retrieve the destination of the data packet (1205). Then, at a step 1204, if the forwarding condition of the reception packet is not satisfied or if the address belonging to the multicast group does not exist on the destination of the self-device, the reception packet is deleted (1210).

At the step 1206, if the next destination exists and the transmitting process is executed, at first, in order to store the data information reestablished from the packet, whether or not a free storage space for memory does not exist in the storage volume of the storage unit 2 managed by the self-device is judged (1207). When judged that free storage space enough for storing the received data does not exist in the storage volume, the data packet is not stored in the storage unit 2 and transmitted to the next forwarder. When the space storable in a packet unit exists in the storage unit 2, the method can be employed in which the data is not established from the packet and while the possibility or impossibility of the transmission at an individual packet unit is checked, the transmission is executed.

At the step 1207, if the sufficient storage space is judged to exist, the data information reestablished from the packet is stored in the storage space of the storage unit 2 (1208). After that, as necessary, the data is fragmented, the header processing of the packet is performed (1209), the packet is transmitted from the appropriate output port (1210), and the series of the processes is ended.

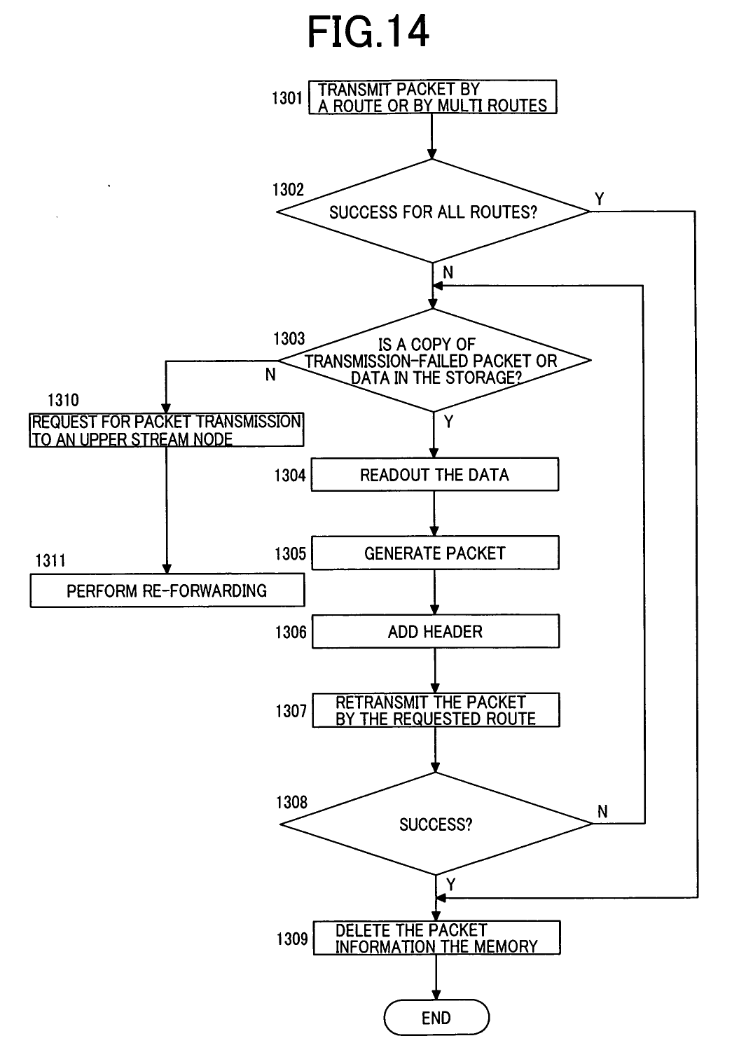

FIG. 14 is a flowchart of the transmission checking process of the data packet in the information forwarder 1000 according to the second embodiment of this invention.

According to the process of FIG. 12 mentioned above, the information forwarder 1000 transmits the data packet on the basis of the L7 multicast forwarding table 50 (1301). Then, the transmission checking process is started.

At first, the transmission about the individual data packet is checked between the information forwarders 1000 of one or a plurality of next stages which are the destinations of the data packet. For this checking technique, the check based on the conventional TCP is allowable, or a new protocol to manage the arrival state of the data packet may be used in the application layer. Then, the transmissions about all of the destinations are checked, and whether or not the transmissions of the packets about all routes are successful is judged (1302).

If the transmissions of the packets about all of the routes are judged to be successful, the information of the packets stored in the storage unit 2 of the self-device is deleted (1309), and the transmission checking process is ended.

If the route where the transmission is failed to the packet destinations, whether or not the data or packet which failed is stored in the storage unit 2 of the self-device is firstly judged (1303). If the data or packet is not stored, the packet retransmission of the data is requested for the upper stream information forwarder 1000 (or the L7 multicast sender 101) (1310). Then, the data packet retransmitted on the basis of the request is transmitted to the downstream information forwarder 1000 of the route where the transmission cannot be checked (1311). The retransmitted received data packet may be stored in the storage unit 2 or may be deleted after the end of the transmission.

At the step 1303, if the data information is stored in the storage unit 2 of the self-device, the data information is extracted (1304), the data information is fragmented into packets (1305), the necessary header is added to each packet (1306), and the generated data packet is retransmitted to the necessary route (1307). Here again, the transmission is checked similarly to the above-mentioned step 1302, and whether or not the retransmission of the data packet is successful is judged (1308). If the retransmission of the data packet fails, the flow of the process returns to the step 1303, and the packet retransmitting process is repeated. If the retransmission of the data packet is successful, the information of the packet is deleted (1309) and the transmission checking process is ended.

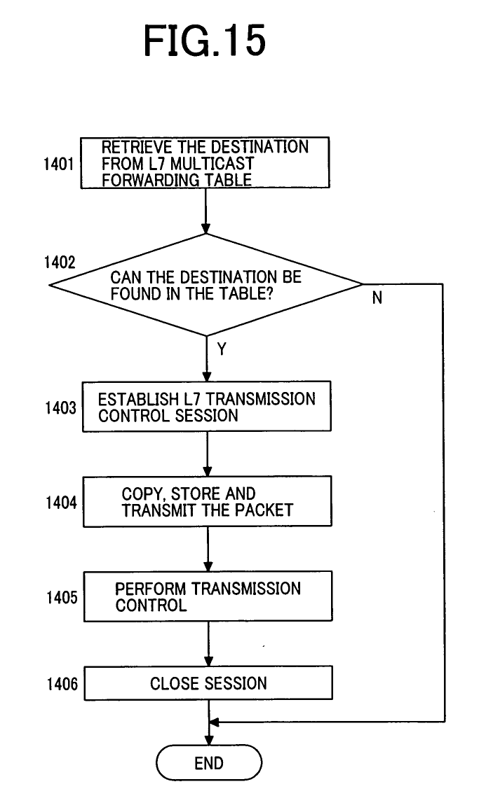

FIG. 15 is a flowchart showing the session establishing process between the adjacent information forwarders 1000 on one route in the information forwarder 1000 according to the second embodiment of this invention.

The information forwarder 1000 receiving the packet, retrieves the L7 multicast forwarding table on the basis of the header of the packet (1401). Then, as the retrieved result, whether or not the destination to be transmitted founds in the L7 multicast forwarding table to the destination of the self-device is judged (1402). If destination to be found, the session for the data packet transmission control is established between the logical output port of the self-device, which is the output port, and the logical input port of the next information forwarder which is the input port (1403). Next, the copying process, the storing process of the data packet received from the upper stream information forwarder 1000, and the transmission process to one or a plurality of next routes which become the destinations of the data packets are executed (1404), and the transmission is checked for each route (session) (1405). The storing process and transmitting process of this data packet are similar to those of the above-mentioned procedure of FIG. 12. Also, the transmission checking process 1405 of the transmission packet is similar to the above-mentioned process of FIG. 13. Then, as for the route in which the transmission of the data packet can be checked, the session is ended (1406), and the session checking process is ended.

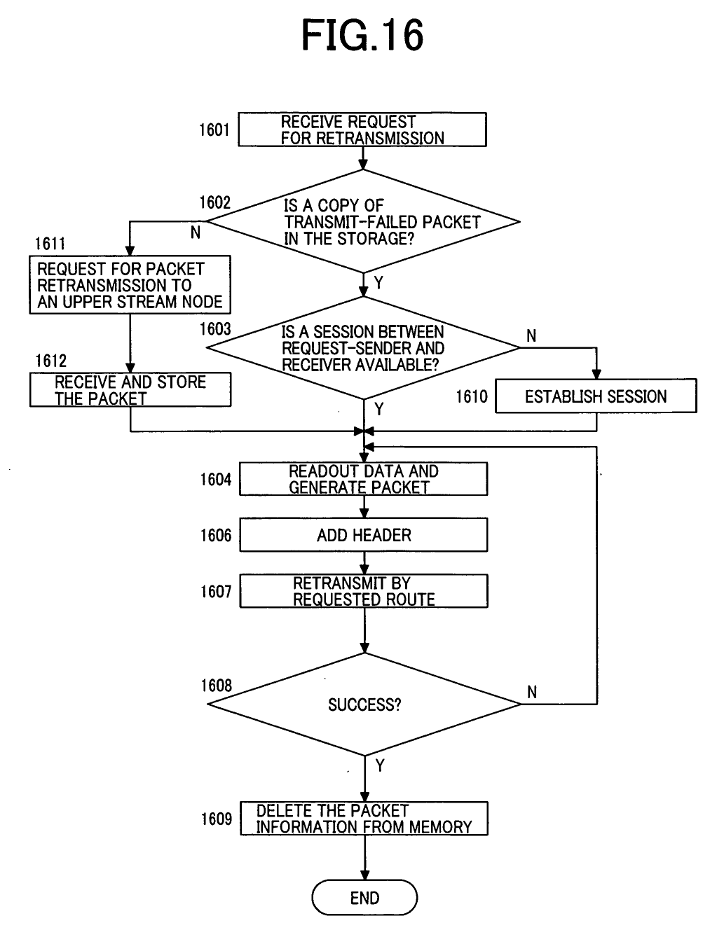

FIG. 16 is a flowchart showing the retransmitting process of the data packet in the information forwarder 1000 according to the second embodiment of this invention.

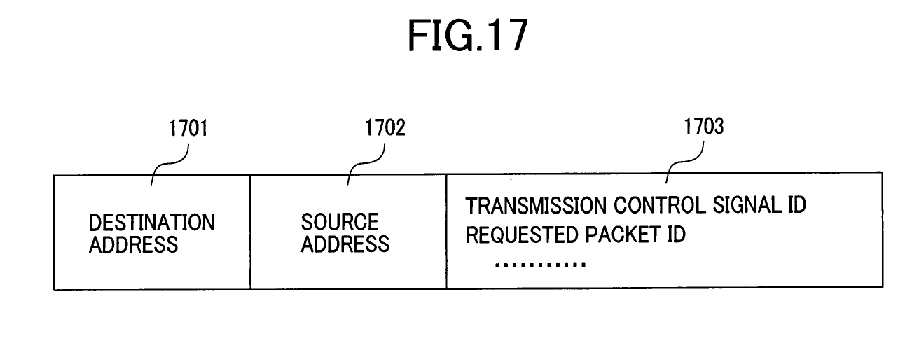

For example, if the congestion and trouble on the route prevent the information forwarder 1000 on the receiving side from checking the transmission of the data packet, the request retransmission packet (FIG. 17) is transmitted to the upper stream information forwarder 1000 that is the source. The information forwarder 1000 on the receiving side receives this request retransmission packet (1601). The information forwarder 1000 having received the request retransmission packet judges whether or not the data or packet which has failed transmission indicating the packet is stored in the self-device (1602). If the data information does not exist in the storage unit 2, the retransmission request packet is similarly transmitted to the further upper stream information forwarder 1000, and the data packet transmission is requested (1611). Then receive and store the packet (1612). If the data information is judged to be stored in the self-device, whether or not the session between request-sender and the forwarder available is established is judged (1603). Usually, if there is the transmission request, because the data packet is being transmitted in the multicast, the session to the downstream information forwarder 1000 is established. Similarly to the processes on and after the step 1304 of FIG. 14 as mentioned above, the data is read (1604), the packet is generated (1605), the necessary header is added (1609), and the retransmitting process is executed (1607).

It should be noted that when the data packet is transmitted to the next information forwarder 1000, if the storage unit 2 does not have enough space available or the self-device is the L7 multicast forwarder having no storage function, the retransmission request from the plurality of information forwarders 1000 may be received. In this case, the session to the information forwarder 1000 of the request sender is not established. Thus, after the session is established (1610), the data packet is retransmitted (1607).

Next, the transmission of the data packet is checked (1608). When the retransmission is success and the retransmission of the data packet is completed, the packet information is deleted (1609) and the retransmitting process is ended.

FIG. 17 is a configuration block diagram of the retransmission request packet.

The header section of the packet includes an L7 address information 1701 of the request destination device and an L7 address of the request sender (source address). Moreover, a header section or data section 1703 includes: a transmission control signal ID to identify a transmission control packet, a request packet ID that is the information of the packet in which the transmission check is unsuccessful, and a division number of a data when the data is made into the packet.

In the information forwarder 1000 having received this retransmission request packet, if it is judged to be the retransmission request by the input unit 10, the data information is extracted by the data processing unit 60 and storage section 70 of the self-device. After the data processing unit 60 re-generates the packet, the switch unit 20 and the output unit 30 transmit the packet.

A third embodiment of this invention will be described below.

In the third embodiment, a network storage address (NSA) is used for the identifier of the distribution destination of the data packet. It should be noted that the same symbols are given to the configurations with the same actions as the first and second embodiments, and their explanations are omitted.

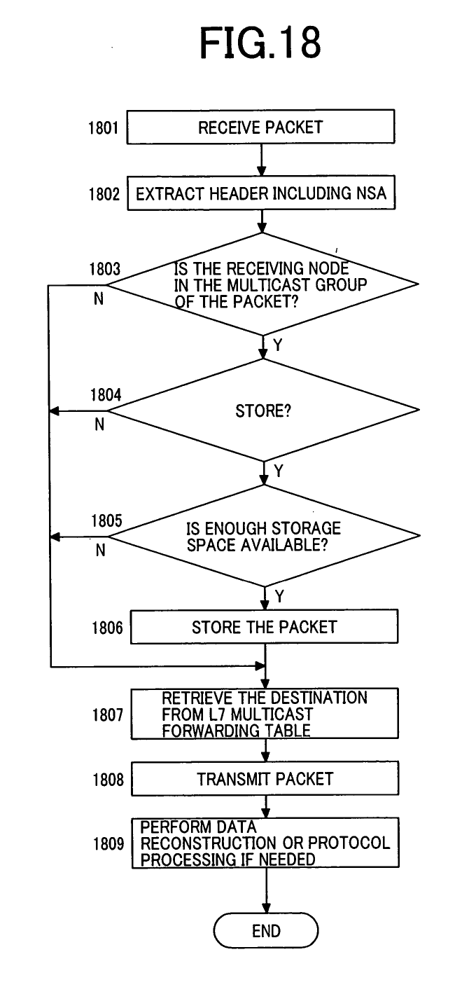

FIG. 18 is a flowchart of the information forwarder 1000 that carries out the L7 multicast by using the group address of the network storage address according to the third embodiment of this invention.

The information forwarder 1000 receiving the data packet (1801), firstly extracts the header of the data packet including NSA and extracts the destination address and the source address (1802). Then, whether or not the NSA assigned to the storage unit 2 of the self-device is the member of the multicast group address that is the destination of the received data packet is judged (1803). If the NSA is the node in the multicast group, whether or not it is the data that can be stored in the storage unit of the self-device is judged on the basis of the data property extracted from the header (1804). If it is not the storable data, the flow of the process proceeds to a step 1807.

In the case of the storable data, whether or not the storage unit 2 has enough space available to store the data packet is firstly judged (1805). If there is enough space available and the data packet is storable, the data packet is stored in the storage unit 2 (1806). If there is not enough space available, the flow of the process proceeds to a step 1807.

At the step 1807, the L7 multicast forwarding table 50 is retrieved from the header, and the transmitting process of the data packet to the necessary destination is executed (1808). It should be noted that if the received data packet is any control signal (for example, the management information of the NSA), or if the data packet information is stored in the storage unit 2, the process for performing the data reconstruction or protocol processing is carried out, if needed (1809).

The above-mentioned processes enable the data distribution through the L7 multicast, even by using the group address of the NSA. In this case, the destination of the data packet becomes the storage unit 2 specified by the NSA.

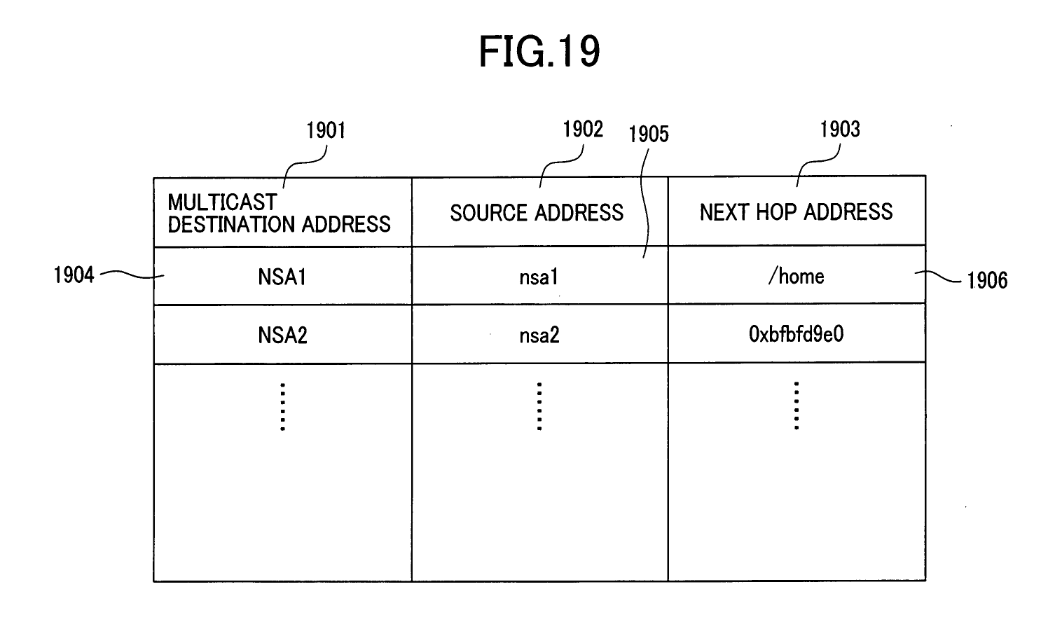

FIG. 19 is a configuration block diagram of the multicast forwarding table in the case of using the network storage address (NSA), in the information forwarder 1000 according to the third embodiment of this invention.

A multicast destination group address 1901 is represented by the representation of the group address bundling the NSA, as mentioned above, in FIG. 3. Used as a source address 1902, the address of a storage region in linkage to the network function of the device transmitting the data. A Next Hop address (destination port) 1903 is represented by the NSA of the device carrying out the forwarding process. This is because the network configuration is represented by the connection between the logical ports identified by the NSA. This NSA includes the position information on the network of the storage unit and the identification information of the storage volume inside the device. For example, it indicates a directory name and a block address of each storage device.

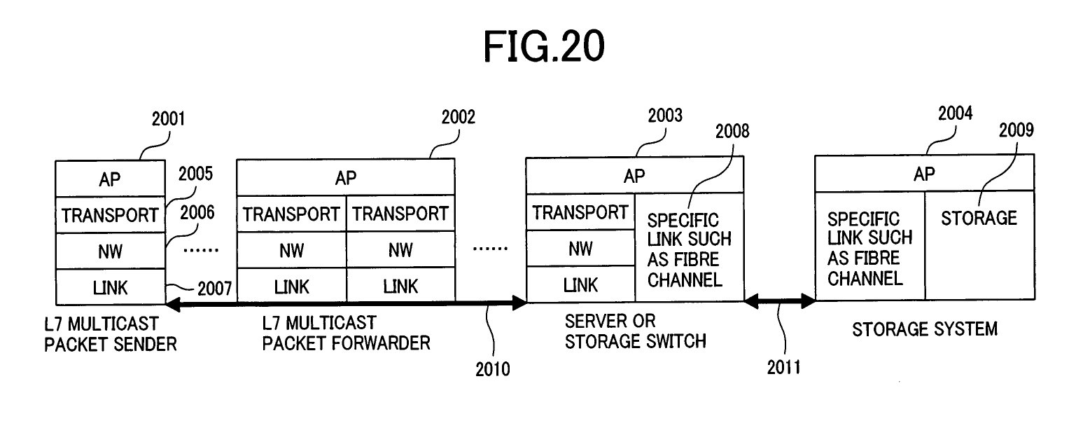

FIG. 20 is an explanatory view showing the protocol stack in the network configuration when the NSA is applied according to the third embodiment of this invention.

The process in the information forwarder 1000 can be usually classified into the processes of application layers 2001 to 2004, a transport layer 2005, a network layer 2006, and a data link layer 2007. In the application layer 2001, the data packet is fragmented in this invention. After a packet is generated, the packet is transmitted. The transmitted packet is sequentially processed in the lower layers, and finally transmitted through the physical lines of the data link layer or its subsequent layers.

In the conventional network technique, the communication is limited to a range 2010 where communication is allowed in the network layer such as the IP network. Also, in a storage area network 2011, a network of a fibre channel or the like is used for a link layer, and the standard specific to the storage is employed by using the storage control command (for example, the SCSI command).

As compared with the network 2010, the storage control command (for example, the SCSI command) corresponds to the higher layer of a transport layer 2105. Here, the communication of a storage 2009 can be performed by forwarding the information in the process for the higher layer, similarly to the method of mutually connecting FC (Fibre Channel) and Ethernet, for example, even in a SAN switch to make the conventional SAN (Storage Area Network) virtual.

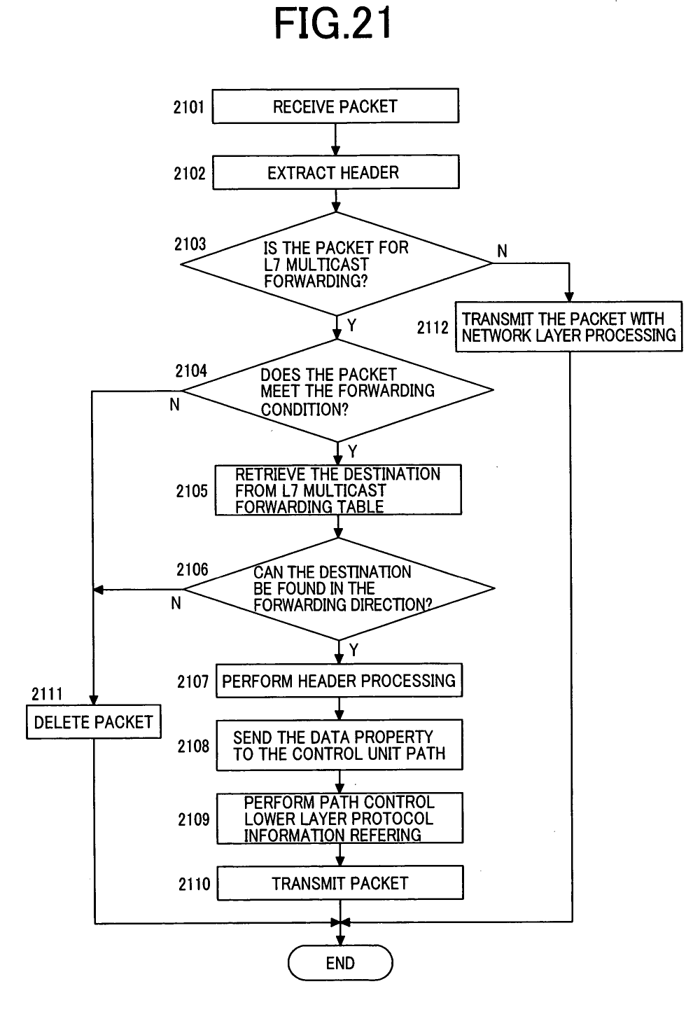

It should be noted that the network storage address is the identifier belonging to the highest layer including the storage control command and the other application processes in FIG. 20, and it can be used to improve the usability of the storage. FIG. 21 is a flowchart showing the transmitting process with reference to the transmission protocol information in the lower layer, in the L7 multicast process.

The steps 2101 through 2107 and the steps 2111 and 2112 in FIG. 21 are the same as the steps 801 through 807 and the steps 809 and 810 in the L7 multicast forwarding control process shown in FIG. 8. Thus, their explanations are omitted.

By controlling the path for the communication using the lower protocol independent of the route retrieval in the L7 multicast, the more efficient distribution becomes possible as compared with the communication only using the conventional lower layer protocol. More specifically, if the node (the information forwarder or the like) of the L7 multicast exists on the destination of the self-device, the route to the next information forwarder 1000 is determined referring to the lower layer protocol information. Then, at the step 2108, the data property is sent to a path control unit of the lower protocol. Next, due to perform referring the lower protocol information, the path route suitable for the priority control condition requested from their addition information is selected from the selectable routes (2109). Then, the data packet is transmitted according to the transmission path (2109). Due to the processes in FIG. 21, for example, the application of VPN, VLAN, and the like to the lower protocol enables the transmission route and destination (transmission group) of the data packet to be specified, which enables the multicast distribution with the higher reliability.

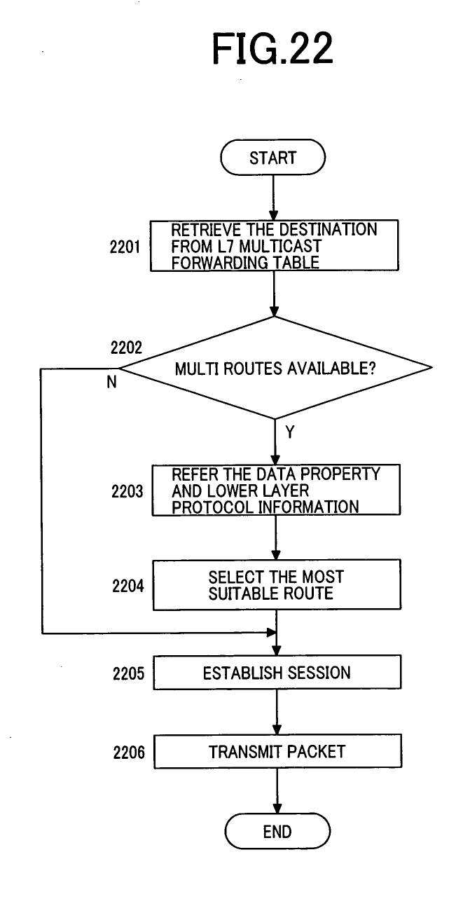

FIG. 22 is a flowchart showing a path control process between the information forwarders with reference to the lower layer protocol information.

At the step 2106 in FIG. 21, if the device as the data packet transmission target is judged to exist on the destination of the self-device, the flow of the process proceeds to a step 2201 of FIG. 22, and it examines to retrieve the destination from L7 multicast forwarding table. Next, at a step 2202, whether or not there are multi routes available to the next forwarder is judged. If there are not multi routes, the flow of the process proceeds to a step 2205. If there are multi routes available, the data property and lower layer protocol information are firstly referred to (2203). Then, one of the suitable routes in the multi-routes is selected on the basis of the requested priority control condition, from the data property information and the forwarding information (2204). In the processes at the steps 2203 and 2204, the information on the line usage situation and connection condition obtained by the actions of the protocols of the network layer and its subsequent layers are firstly referred to is used for the route selection. Next, the selected route is used to establish the session (2205). Then, through the established session, the data packet is transmitted (2206).

It should be noted that at the step 2205, the data can be transmitted by using the VPN and the VLAN and establishing the session, in order to more safely transmit the data packet between the devices, if necessary, on the basis of the information contained in the data packet. At this time, the data packet includes the information to identify the VPN or VLAN as the header.

Such design makes the efficiency at the time of the content distribution higher, and gives the reliability to the distribution of the mainframe data and then provides the technique to prompt the improvement of the task efficiency. Also, the communication can be executed beyond the limits of the various communication protocols. In particular, the forwarding control with reference to the protocol information of the lower positions, such as the VPN and the VLAN, enables the flexible route establishment and the improvement of the reliability in the transmission.

It should be noted that this invention can be implemented to function as the high function router having the storage. Also, since this invention can be applied to the system in which the storage unit and the router device and the server to link them are combined, and thus easily introduced to the conventional network system.

It should be noted that this invention includes the following embodiments as an example.

### Sixteenth Embodiment

The information forwarder in which the storage section stores the received data packet, in at least one of the condition of the data packet and the condition of the data information where the data packet is reestablished.

### Seventeenth Embodiment

The information forwarder according to the sixteenth embodiment of this invention, in which the storage section stores the stored data packet or data information, at least until the completion of the transmission of the data packet or data information.

### Eighteenth Embodiment

The information forwarder according to the sixteenth embodiment of this invention, in which when the receiving device receives the retransmission request with regard to the data packet transmitted by the transmitter, the transmitter again transmits the data packet or data information stored in the storage section according to the retransmission request.

### Nineteenth Embodiment

The information forwarder in which the forwarding control unit distributes the received data packet in the multicast, if the data packet received by the receiving device includes a multicast group address identified in an application layer.

### Twentieth Embodiment

The packet forwarder according to the fifteenth embodiment of this invention, in which the identifier identified in the application layer is a network storage address.

### Twenty-First Embodiment

The information forwarder according to the twentieth embodiment of this invention, in which the network storage address includes the identification information to identify at least one of the position on the network of the information forwarder, the identification information of the storage volume physically or logically classified in the storage section, and the storage position of the data packet or data information inside the storage volume of the storage section.

### Twenty-Second Embodiment

The information forwarder according to the twenty-first embodiment of this invention, in which the forwarding control unit determines the destination of the received packet according to the transmission protocol of the layer lower than the application layer.

### Twenty-Third Embodiment

A network system, including a plurality of information forwarders that distribute data packets,

in which:

the information forwarder has a forwarding table to specify a route of the network system by using an identifier identified in an application layer;

the route is controlled, on the basis of a forwarding information identified in the application layer, from the information forwarder on an upper stream side to the information forwarder on a downstream side;

the data packet is received;

a destination of the data packet is determined according to an information contained in the received data packet and the forwarding table; and

the received data packet is transmitted on the basis of the determined destination.

### Twenty-Fourth Embodiment

The network system according to the twenty-third embodiment of this invention, in which the identifier identified in the application layer is a multicast group address.

### Twenty-Fifth Embodiment

The network system according to the sixteenth embodiment of this invention, in which the identifier identified in the application layer is a network storage address.

While the present invention has been described in detail and pictorially in the accompanying drawings, the present invention is not limited to such detail but covers various obvious modifications and equivalent arrangements, which fall within the purview of the appended claims.

1. A method of distributing a data packet in a network system provided with a plurality of information forwarders, the information forwarder including a forwarding table to specify a route of the network system by using an identifier identified in an application layer, comprising:
setting the route on the basis of a forwarding information identified in the application layer, for the information forwarder on a destination from the information forwarder on an upper stream side;
receiving the data packet;
determining a destination of the data packet according to an information included in the received data packet and the forwarding table; and
transmitting the received data packet, on the basis of the determined destination.

2. The method according to claim 1,
wherein the information forwarder further includes a storage unit which stores the data packet, stores the received data packet in the storage unit, and transmits the stored data packet, on the basis of the determined destination.

3. The method according to claim 1,
wherein the data packet comprises a header section and a data section, and the header section includes a destination address described by the identifier identified in the application layer and a source address described by the identifier identified in the application layer.

4. The method according to claim 2,
wherein when the data packet is transmitted, whether the data packet is correctly transmitted is checked.

5. The method according to claim 4,
wherein when the data packet is correctly transmitted, the route where the packet has been transmitted correctly is released, and the forwarding information is set.

6. The method according to claim 4,
wherein when the data packet is not transmitted correctly, a retransmission of the data packet is requested, and on the basis of the request of the retransmission, the data packet is again transmitted.

7. The method according to claim 2,
wherein a data information in which the received data packet is reestablished is stored in the storage unit.

8. The method according to claim 1,
wherein an ID to identify a destination of the data packet is used as the identifier identified in the application layer.

9. The method according to claim 1,
wherein an ID to indicate a geographical position or region or a physical position or region to identify a destination of the data packet is used as the identifier identified in the application layer.

10. The method according to claim 1,
wherein the identifier identified in the application layer comprises a multicast group address.

11. The method according to claim 10,
wherein the identifier identified in the application layer comprises a network storage address.

12. The method according to claim 11,
wherein the storage unit included in the information forwarder is specified by using the network storage address.

13. The method according to claim 11,
wherein the forwarding table includes a destination address to identify the destination of the data packet indicated by the network storage address.

14. An information forwarder for transmitting a data packet, comprising:
a input unit which receives the data packet;
a output unit including one or a plurality of output ports which transmits the data packet;
a switch unit which switches a route between the input unit and the output unit; and
a forwarding control unit which controls the switch unit, on the basis of a destination information of the data packet,
wherein the input unit extracts a header of the received data packet and informs the header to the forwarding control unit,
wherein the forwarding control unit has a multicast forwarding table determining an information with regard to a destination of the data packet by using an identifier identified in an application layer, selects the destination of the data packet from the output unit on the basis of the notified header and the multicast forwarding table, and notifies the switch unit of the destination of the selected data packet,
wherein the switch unit switches a route between the input unit and the output unit on the basis of the notification,
wherein the output unit processes a destination information of the data packet on the basis of a selection result of the switch unit,
wherein the data packet is transmitted from the output unit.

15. The information forwarder according to claim 14, further comprising a storage unit which stores the data packet,
wherein the storage unit stores the received data packet,
wherein the output unit processes the destination information of the stored data packet on the basis of the selection result of the switch unit,
wherein the stored data packet is transmitted from the output unit.

16. A network system, comprising a plurality of information forwarders to distribute data packets,
wherein the information forwarder comprises: a forwarding table to specify a route of the network system by using an identifier identified in an application layer; and a storage unit which stores the data packet,
wherein the route is set on the basis of a forwarding information identified in an application layer, from the information forwarder on an upper stream to the information forwarder on a destination,
wherein the data packet is received,
wherein a destination of the data packet is determined according to an information contained in the received data packet and the forwarding table,
wherein the received data packet is stored in the storage unit,
the stored data packet is transmitted on the basis of the determined destination.
